(19) United States
(12) Patent Application Publication
(10) Pub. No.: US 2025/0034039 A1
(43) Pub. Date: Jan. 30, 2025

(54) ANTI-STRENGTH-RETROGRESSION CEMENTING SYSTEM WITH EXCELLENT PUMPABILITY PERFORMANCE AND PREPARATION METHOD THEREOF

(71) Applicant: China University of Petroleum (East China), Qingdao (CN)

(72) Inventors: Xueyu PANG, Qingdao (CN); Guodong CHENG, Qingdao (CN); Chuangchuang WANG, Qingdao (CN); Jiankun QIN, Qingdao (CN); Kaihe LV, Qingdao (CN); Jinsheng SUN, Qingdao (CN)

(73) Assignee: China University of Petroleum (East China), Qingdao (CN)

(21) Appl. No.: 18/911,345

(22) Filed: Oct. 10, 2024

Related U.S. Application Data
(63) Continuation of application No. PCT/CN2022/095502, filed on May 27, 2022.

(30) Foreign Application Priority Data
Apr. 11, 2022 (CN) 2022103738604

(51) Int. Cl. C04B 7/24

(52) U.S. Cl. CPC C04B 7/243

(57) ABSTRACT

The present application pertains to the cementing engineering technical field and reveals a cement system for ultra-high temperature resistance with excellent pumpability performance, as well as its preparation method. This cement system comprises a solid component and a liquid component. The solid component is comprised of a weight percentage of 14-70% cement, 3-80% silica sand, 3-80% fly ash, and 3-80% slag powder. The liquid component includes water and additives. This high-temperature resistant cement system exhibits stable performance with a thickening time generally exceeding 6 hours. The initial consistency ranges from 23.8 Bc to 33.6 Bc, exhibiting good pumpability performance. Furthermore, the system maintains stable strength and water permeability during the curing periods from 2 days to 90 days. The high-temperature resistant cementing system provided by this application can overcome the problems of long-term strength retrogression and address issues associated with high initial consistency, pumping difficulty, and short thickening time.

### CROSS-REFERENCE TO RELATED APPLICATIONS

The application claims priority to Chinese patent application No. 2022103738604, filed on Apr. 11, 2022, the entire contents of which are incorporated herein by reference.

### TECHNICAL FIELD

The present application relates to the technical field of cementing engineering, and in particular to an anti-strength-retrogression cementing system with excellent pumpability performance and preparation method thereof.

### BACKGROUND

Due to the high pressure and high temperature (HPHT) conditions underground, the exploration of deep oil and gas reserves poses significant challenges to the well cementing system. Different from steam-injection wells for heavy oil extraction, where the well cement typically set at low temperatures before high-temperature exposure, the cementing of deep and ultra-deep wells require the cement slurry to set under HPHT conditions. Recent studies showed that (Pang X, Qin J, Sun L, et al. Long-term strength retrogression of silica-enriched oil well cement: A comprehensive multi-approach analysis [J], Cement and Concrete Research, 2021, 144:106424; Li Ning, Pang X, Al Z, et al. Composition optimization and strength decline mechanism of oil well cement slurry at 200° C. [J]. Journal of the Chinese Ceramic Society, 2020,48 (11): 1824-1833), the traditional silica-enriched Class G oil well cement systems experienced significant strength retrogression during long-term curing (>30 d) at the ultra-high temperature of 200° C., due to the coarsening of microstructure. Various influencing factors have been studied, including the optimization of silica-based admixtures, increasing curing pressure and adding physical reinforcement materials, but these methods all failed (Qin J, Pang X, Santra A, et al. Various admixtures to mitigate the long-term strength retrogression of Portland cement cured under high pressure and high temperature conditions, Journal of Rock Mechanics and Geotechnical Engineering, 2023, 15 (1): 191-203; Qin J, Pang X, Cheng G, et al. Influences of different admixtures on the properties of oil well cement systems at HPHT conditions. Cement and Concrete Composites, 2021, 123:104202; Liu H, Qin J, Zhou B, et al. Effects of curing pressure on the long-term strength retrogression of oil well cement cured under 200° C. Energies, 2022, 15 (16): 6071.). This poses significant challenges to ensure effective long-term sealing of the wellbore annulus following a successful cementing operation, which may ultimately result in wellbore integrity failure and abandonment.

The thickening time of cement slurry represents its pumpable time, which is crucial for on-site cementing operation safety. The development of well cement strength is important for cementing quality and long-term sealing of the wellbore annulus. During the design of cement slurry systems, it is essential to consider both workability and mechanical properties. Fly ash and slag are recognized as valuable concrete admixtures for the preparation of high-performance concrete. However, there are numerous shortcomings associated with utilizing fly ash and slag to address the issue of high-temperature strength decline in traditional silica-enriched systems. For instance, the addition of slag can prevent the strength decline of silica-enriched cement systems during the 30-day curing period, but it failed to prevent the strength decline during the 90-day curing period (Cheng G, Pang X, Wang H, et al. Anti-strength retrogression cementing materials for deep and ultra-deep wells. Construction and Building Materials, 2024, 411:134407.). The addition of fly ash can prevent the 90-day strength retrogression of traditional silica-enriched cement systems, but it significantly increased the initial consistency (which is related to viscosity) of cement slurry and made the pumpability performance very poor, which could hamper on-site cementing operations (patent publication CN113582605B). Patent publications CN102153996, CN112194389A, and CN110092597B disclosed high-temperature resistant geopolymer cementing systems. However, the geopolymer systems has yet to see a full-scale implementation in oil and gas well cementing operations due to various factors such as lack of supporting standards and additives.

Based on the analysis above, the problems associated with conventional techniques are as follows:

The addition of silica is a prevalent technique utilized in the industry to prevent the strength retrogression of set cement cured at HPHT conditions. However, research on admixtures other than silica sand remains relatively limited.

Previous studies indicated that even optimized traditional silica-enriched Class G oil well cement systems still experienced significant long-term strength retrogression when directly exposed to HPHT conditions before setting.

Previous studies to address strength retrogression have predominantly focused on short curing periods. It is difficult to accurately assess the long-term sealing integrity of wellbore under HPHT conditions.

### SUMMARY

Taking into account the issues present in traditional technology, this application offers a high-temperature resistant cementing system with exceptional pumpability performance and its preparation method.

The implementation of this application is as follows: an ultra-high temperature resistant cementing system with exceptional pumpability performance, composed of solid component and liquid component; the weight ratio of solid component to liquid component is 1: (0.23-0.83); the solid component consists of cement, silica sand, fly ash, and slag powder; the liquid component is composed of water and additives.

The solid component includes a weight percentage of 14-70% cement, 3-80% silica sand, 3-80% fly ash, and 3-80% slag powder. The weight ratio of silica sand to fly ash, or silica sand to slag powder, or fly ash to slag powder is (0.05-24): 1.

The liquid component includes a weight percentage of 70-90% water and 10-30% additives.

Furthermore, the type of cement used isclass G oil well cement.

Furthermore, the silica sand contains over 95% SiO₂.

Furthermore, the particle size D90 of the silica sand exhibits a range of 38.6 to 206 μm.

Furthermore, the fly ash used comes from coal-fired power plants.

Furthermore, the slag powder can be either S75 grade, S95 grade, or S105 grade slag powder.

Furthermore, the additive contains a retarder.

Furthermore, the additive further contains at least one of the following: a suspending agent, a dispersing agent, a fluid loss reducer, or a defoaming agent.

Another objective of this application is to provide a method for preparing an ultra-high temperature resistant cementing system with exceptional pumpability performance, following these steps:
Step 1: Mix cement, silica sand, and slag powder in the specified proportions to obtain solid component A.
Step 2: Weigh the fly ash to obtain solid component B.
Step 3: Mix water and additives according to the specified proportions to obtain liquid component C.
Step 4: At a stirring speed of 4000 rpm, adding the solid component A obtained in step 1 to the liquid component C obtained in step 3. After the addition, stirring the mix components at a speed of 12000 rpm for 35 seconds. Following this, slowly adding the solid component B obtained from step 2 to the mix components at a low speed (600 rpm). Once added, stirring the mix component at a speed of 3000 rpm for 35 seconds to obtain a high-temperature resistant cementing system.

Based on the aforementioned technical solutions and the resolved technical issues, this article analyzes the advantages and positive effects of protected technical solution from the following perspectives:

Firstly, when considering the technical solution as a whole or from a product viewpoint, the specific technical effects and advantages of the protected technical solution can be described as follows:

The differential impact of slag and fly ash on the thickening time performance of cement slurry is worthy of consideration. In general, fly ash has the effect of increasing the viscosity of cement slurry, whereas slag has the opposite effect, reducing the viscosity. This application creatively sets the weight ratio of slag to fly ash within the range of (0.05-24): 1, and add silica sand component at a weight ratio of 3-80% to regulate the CaO/SiO₂ ratio in the system and enrich the SiO₂ type in the system. Furthermore, a liquid component is introduced at a ratio of 1:0.23-0.83. The liquid component is composed of 70-90% water and 10-30% additives. The resulting cement slurry system exhibits a thickening time exceeding six hours, with an initial consistency ranging from 23.8 Bc to 33.6 Bc. Subsequently, the system is directly set and cured under conditions of 200° C. and 50 MPa, with curing period of 2 days and 90 days, respectively. The findings demonstrate that the compressive strength and water permeability of the system remain stable throughout the 90-day curing period. Following a curing period of 90 days, the compressive strength of the set cement exceeded 35 MPa, representing a slight increase in comparison to the strength observed after 2 days. Furthermore, during the long-term curing process, the pore throat diameter of the set cement remains stable or decreases, indicating the inhibition of microstructural coarsening of the set cement. The experimental results demonstrate that this system not only exhibits good pumpability performance (appropriate initial consistency and thickening time) but also addresses the issue of long-term strength retrogression of set cement under HPHT conditions. This offers valuable technical support and theoretical guidance for the cementing of deep oil and gas wells.

Secondly, important supporting evidence for the claims of this application is also evident in the following aspects:

(1) The anticipated revenue and commercial value following the implementation of the technical scheme outlined in this application are as follows:

Both fly ash and slag are classified as industrial solid waste, typically utilized as additives for cement and concrete, with limited use for high added value. However, with the present application, fly ash and slag are employed for the preparation of an ultra-high temperature resistant cementing system, thereby applying industrial solid waste to the specialized field of ultra-high temperature cementing, resulting in significant commercial value.

(2) The technical solution provided by this application fills a void in both domestic and foreign industries:

As deep and ultra-deep oil and gas exploration activities increase, the high temperature encountered in deep wells pose considerable challenges for cementing engineering. The strength retrogression of set cement can lead to compromised wellbore integrity and premature abandonment of production wells, becoming a significant constraint on deep oil and gas development. In response to this, this application proposes using fly ash and slag powder in combination to prevent the long-term retrogression of traditional silica-enriched systems under HPHT conditions. Through long-term curing of 90 days under simulated 200° C. ultra-deep well conditions (directly set and cured at high temperature conditions), a high-temperature resistant cementing system has been developed. This system demonstrates moderate initial consistency, excellent pumpability performance, stable strength, permeability, and other properties. The successful implementation of this system in the field is expected to provide technical support for the smooth development of deep oil and gas resources in deep and ultra-deep layers.

(3) Does the technical solution presented in this application effectively address a long-standing technical problem that has proven challenging to solve?

In the past, research in this field has faced the following challenges: (I) The low set temperature of set cement has made it difficult to accurately simulate the cementing environment of ultra-deep wells. (II) The curing period was short, usually less than 30 days, and unable to guarantee the long-term integrity of the wellbore. (III) Poor pumpability performance, and difficulties in construction and application. To address these issues, the present application has developed an ultra-high temperature resistant cementing system with excellent pumpability performance. This system exhibits good initial consistency and adjustability, enables effective construction pumping, and maintains stable strength for 90 d curing period under simulated deep well conditions of 200° C. This successful development effectively overcomes the aforementioned problems.

(4) Does the technical solution of the present application overcome technical biases?

In the past, the cementing industry commonly addressed the problem of high-temperature strength decline of set cement by adding silica sand or optimizing parameters of silica, such as particle characteristics, type, and dosage. Other admixtures, apart from silica sand, were rarely used. While fly ash and slag powder have been used as admixtures for cement and concrete, this is the first instance of combining fly ash and slag powder to prevent the long-term strength retrogression of traditional silica-enriched cementing systems under HPHT conditions. Moreover, this combination also reduced the initial consistency of cement slurry and made it easy to pump.

### BRIEF DESCRIPTION OF THE DRAWINGS

FIG. 1 presents a flowchart illustrating a preparation method for an ultra-high temperature resistant cementing system with exceptional pumpability performance, as provided by an embodiment of the present application.

FIG. 2 and FIG. 3 shows the test results of thickening time property under the conditions of 180° C. and 90 MPa, as well as 180° C. and 120 MPa.

FIG. 4 displays the results of compressive strength for 2 days and 90 days at 200° C. and 50 MPa, respectively, for the ultra-high temperature resistant cementing system provided by the embodiment of the present application, as well as the cementing systems of Comparative Examples 1 and 2.

FIG. 5 exhibits the XRD diffraction patterns and mineral composition analysis results of the ultra-high temperature resistant cementing system with exceptional pumpability performance provided in the embodiment of the present application. The specimens are set and cured for 2 and 90 days under the conditions of 200° C. and 50 MPa, respectively.

FIG. 6 presents the test results of water permeability of each set cement in the ultra-high temperature resistant cementing system with exceptional pumpability performance provided by the embodiment of the present application. The cement systems of Comparative Example 1 and Comparative Example 2 are set and cured for 2 days and 90 days respectively at 200° C. and 50 MPa.

FIG. 7 demonstrates the test results of the pore throat diameter distribution for the ultra-high temperature resistant cementing system with exceptional pumpability performance provided by the embodiment of the present application. The cementing system is set and cured for 2 days and 90 days respectively at 200° C. and 50 MPa.

### DETAILED DESCRIPTION OF THE EMBODIMENTS

In order to provide a clearer understanding of the objective, technical solution, and advantages of present disclosure, the present disclosure is further described in detail with examples. It should be noted that the specific embodiments described herein are merely intended to illustrate the present disclosure and should not be construed as limiting the scope of the present disclosure.

1. The following section provides an explanation of the embodiment. In order to facilitate a comprehensive understanding of the implementation of the present disclosure among those with the requisite technical expertise, this section provides an illustrative explanation and an exemplar of the implementation of the claimed technical solution.

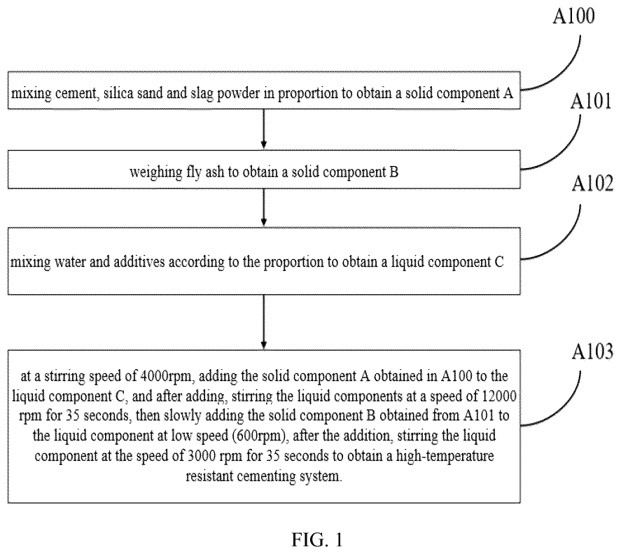

As illustrated in FIG. 1, the following preparation method for an ultra-high temperature resistant cementing system with excellent pumpability performance, provided by the embodiment of the present disclosure, comprises:
A100: Mix cement, silica sand, and slag powder in proportion to obtain a solid component A;
A101: Weigh fly ash to obtain a solid component B;
A102: Mix water and additives according to the required proportions to obtain a liquid component C;
A103: Under a stirring speed of 4000 rpm, adding the solid component A obtained in A100 to the liquid component C obtained in A102. After that, stirring the liquid components at a speed of 12000 rpm for 35 seconds, then slowly adding the solid component B obtained from A101 to the liquid component at a low speed (600 rpm). After the addition, stirring the liquid component at a speed of 3000 rpm for 35 seconds to obtain a high-temperature resistant cementing system.

In the preparation process, it is necessary to add fly ash slowly to the other solid and liquid components at a low speed while mixing and stirring at a high speed.

The high-temperature resistant cementing system provided by the embodiment of the present disclosure consists of a solid component and a liquid component, with a weight ratio of the solid component to the liquid component being 1: (0.23-0.83).

The solid component is composed of 14-70% cement, 3-80% silica sand, 3-80% fly ash, and 3-80% slag powder. The weight ratio of silica sand to fly ash, silica sand to slag powder, or fly ash to slag powder is in the range of (0.05-24): 1. The liquid component comprises water and additives.

The weight ratio of solid component to liquid component in the embodiment of the present disclosure can be 1:0.23, 1:0.33, 1:0.43, 1:0.53, 1:0.63, 1:0.73, and 1:0.83.

In a preferred embodiment, the solid component is composed of 18-65% cement, 6-70% silica sand, 6-70% fly ash, and 6-70% slag powder. The ratio of silica sand to fly ash, silica sand to slag powder, or fly ash to slag powder is (0.115-11): 1.

In a specific embodiment, the dosage of cement, silica sand, fly ash, and slag powder in solid component may be different. The dosage of cement in the solid component may be 14%, 20%, 26%, 32%, 38%, 44%, 50%, 56%, 62%, or 68%. The dosage of silica sand in the solid component may be 3%, 8%, 13%, 18%, 23%, 28%, 33%, 38%, 43%, 48%, 53%, 58%, 63%, 68%, 73%, or 80%. The dosage of fly ash in the solid component may be 3%, 8%, 13%, 18%, 23%, 28%, 33%, 38%, 43%, 48%, 53%, 58%, 63%, 68%, 73%, or 80%. The dosage of slag powder in the solid component may be 3%, 8%, 13%, 18%, 23%, 28%, 33%, 38%, 43%, 48%, 53%, 58%, 63%, 68%, 73%, or 80%.

In a preferred embodiment, the cement used is class G oil well cement. In a specific embodiment, the class G oil well cement is composed of 46% C₃S, 28% C₂S, 19.7% C₄AF, and 6.4% gypsum, representing the primary mineral components.

The silica sand used in this embodiment contains more than 95% SiO₂.

Preferably, the particle size D90 of the silica sand is within the range of 38.6-206 μm. Specifically, the particle size D90 can be 38.6 μm, 40 μm, 50 μm, 75 μm, 100 μm, 125 μm, 150 μm, 175 μm, 200 μm, or 206 μm.

In this embodiment, the silica sand used is conventional quartz sand for oil well cement, and the particle size D90 is 163 μm.

In a preferred embodiment, the fly ash used contains more than 30% SiO₂ and more than 20% Al₂O₃.

In a preferred embodiment, the particle size D90 of fly ash is in the range of 5-175 μm. Specifically, the particle size D90 can be 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, or 175 μm.

In a preferred embodiment, the fly ash used is obtained from coal-fired power plants.

In a preferred embodiment, the slag powder used is either grade S75, grade S95, or grade S105. Taking into consideration the thickening time and mechanical properties of cementing system, the preferred choice for slag powder is grade S95.

In a preferred embodiment, the additive includes a retarder. Furthermore, it is preferable for the additive to also contain at least one of the following: a suspending agent, a dispersing agent, a fluid loss reducer, and a defoaming agent.

The majority of additives referenced in this document are polymers, which can exist in either a solid or liquid state. The specific form of the additives is contingent upon the various properties of the slurry, including its density, rheology, thickening time, and fluid loss. Furthermore, it is typically adjusted in accordance with the actual engineering application conditions.

The additives mentioned in this application can be obtained through commercial channels.

In a preferred embodiment, the liquid component is composed of 70-90% water and 10-30% additives.

2. Evidence of the relevant effects of the embodiment. The embodiment described in this application has achieved significant positive results during the research and development process or in practical applications. It possesses considerable advantages over conventional technologies. The following contents will be combined with test data, charts, and other supporting evidence. However, it should be emphasized that the protection scope of this application is not limited solely to these examples.

The class G oil well cement, silica sand, fly ash, and slag powder utilized in this embodiment are all purchased from the existing market. The fly ash is sourced from coal-fired power plants, and the slag powder is S95 grade. The additives used in this process are also purchased, including BCJ-300S as a suspending agent, BCD-210L as a dispersant, BCR-300L as a retarder, BXF-200L as a filtrate reducer and G603 as a defoamer. The suspending agent is in solid powder form, while the dispersant, retarder, and fluid loss reducer are all aqueous solutions with an effective content of 20%. If specific technologies or conditions are not mentioned in the examples, they should be carried out according to standard practices in the field or the product specifications. The reagents or instruments used, without specifying the manufacturer, are legitimate products that can be acquired through legal channels.

### FIRST EMBODIMENT

The embodiment of the present application provides an ultra-high temperature resistant cement system with excellent pumpability performance. This system comprises a solid component and a liquid component, with a weight ratio of 1:0.39 between the solid component and the liquid component.

The solid component is composed of 36.28% class G oil well cement, which primarily includes 46% C₃S, 28% C₂S, 19.7% C₄AF, and 6.4% gypsum. Additionally, it contains 27.43% silica sand (D90=163 μm), 29.02% S95 slag (D90-29.863 μm, containing 29.438% SiO₂ and 14.125% Al₂O₃), and 7.27% fly ash (D90=10.51 μm, containing 47.057% SiO₂ and 39.465% Al₂O₃).

The liquid component is composed of 78.20% water, 2.27% suspending agent, 6.81% dispersant, 6.81% retarder, 5.45% fluid loss reducer, and 0.46% defoaming agent.

The preparation process for the ultra-high temperature resistant cement system with excellent pumpability performance, according to this embodiment, is as follows:
Step 1: Mix cement, silica sand, and S95 slag powder in the specified proportions to obtain solid component A.
Step 2: Weigh a specific amount of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, continue stirring the liquid components at a speed of 12000 rpm for 35 seconds. Then, slowly add the solid component B obtained from step 2 to the liquid component at a low speed of 600 rpm. After the addition, stir the liquid component at a speed of 3000 rpm for 35 seconds to obtain a high-temperature resistant cementing system.

### SECOND EMBODIMENT

The embodiment of the present application provides an ultra-high temperature resistant cement system with excellent pumpability performance. This system comprises a solid component and a liquid component, with a weight ratio of 1:0.40 between the solid component and the liquid component.

The solid component is composed of 37.41% class G oil well cement, which primarily includes 46% C₃S, 28% C₂S, 19.7% C₄AF, and 6.4% gypsum. Additionally, it contains 25.18% silica sand (D90=163 μm), 11.22% S95 slag powder (D90=29.863 μm, containing 29.438% SiO₂ and 14.125% Al₂O₃), and 26.19% fly ash (D90=10.51 μm, containing 47.057% SiO₂ and 39.465% Al₂O₃).

The liquid component is composed of 77.46% water, 2.34% suspending agent, 7.04% dispersant, 7.04% retarder, 5.63% fluid loss reducer, and 0.49% defoaming agent.

The preparation process of an ultra-high temperature resistant cement system with excellent pumpability performance, as provided by the embodiment of the present application, is described as follows:
Step 1: Mix cement, silica sand, and S95 slag powder in the specified proportions to obtain solid component A.
Step 2: Weigh a specific amount of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, continue stirring the liquid components at a speed of 12000 rpm for 35 seconds. Then, slowly add the solid component B obtained from step 2 to the liquid component at a low speed of 600 rpm. After the addition, stir the liquid component at a speed of 3000 rpm for 35 seconds to obtain a high-temperature resistant cementing system.

### THIRD EMBODIMENT

The ultra-high temperature resistant cementing system with excellent pumpability performance, provided by the embodiment of the present application, consists of a solid component and a liquid component, with a weight ratio of 1:0.5.

The solid component comprises 20.40% class G oil well cement, with the main mineral components including 46% C₃S, 28% C₂S, 19.7% C₄AF, and 6.4% gypsum. It also contains 36.73% silica sand (D90=163 μm) and 36.73% S95 slag powder (D90=29.863 μm), which contains 29.438% SiO₂ and 14.125% Al₂O₃. Additionally, it includes 6.14% fly ash (D90=10.51 μm), containing 47.057% SiO₂ and 39.465% Al₂O₃.

The liquid component is composed of 86.76% water, 1.37% suspending agent, 4.14% dispersant, 4.14% retarder, 3.31% fluid loss reducer, and 0.28% defoaming agent.

The preparation process of the ultra-high temperature resistant cementing system with excellent pumpability performance, as provided by the embodiment of the present application, is as follows:
Step 1: Mix cement, silica sand, and S95 slag powder in the specified proportions to obtain solid component A.
Step 2: Weigh a specific amount of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, continue stirring the liquid components at a speed of 12000 rpm for 35 seconds. Then, slowly add the solid component B obtained from step 2 to the liquid component at a low speed of 600 rpm. After the addition, stir the liquid component at a speed of 3000 rpm for 35 seconds to obtain a high-temperature resistant cementing system.

### FOURTH EMBODIMENT

The embodiment of the present application provides an ultra-high temperature resistant cementing system with excellent pumpability performance. It consists of a solid component and a liquid component, with a weight ratio of 1:0.6 between the solid component and the liquid component.

The solid component is composed of 31.25% class G oil well cement (composed of 46% C₃S, 28% C₂S, 19.7% C₄AF, and 6.4% gypsum), 56.25% silica sand (with D90=163 μm), 6.25% S95 slag powder (with D90-29.863 μm, containing 29.438% SiO₂ and 14.125% Al₂O₃), and 6.25% fly ash (with D90=10.51 μm, containing 47.057% SiO₂ and 39.465% Al₂O₃).

The liquid component is composed of 80.13% water, 2.06% suspending agent, 6.21% dispersant, 6.21% retarder, 4.97% fluid loss reducer, and 0.42% defoaming agent.

The preparation process of the ultra-high temperature resistant cementing system with excellent pumpability performance provided by this embodiment is as follows:
Step 1: Mix cement, silica sand, and S95 slag powder in the specified proportions to obtain solid component A.
Step 2: Weigh a specific amount of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, continue stirring the liquid components at a speed of 12000 rpm for 35 seconds. Then, slowly add the solid component B obtained from step 2 to the liquid component at a low speed of 600 rpm. After the addition, stir the liquid component at a speed of 3000 rpm for 35 seconds to obtain a high-temperature resistant cementing system.

### FIFTH EMBODIMENT

The fifth embodiment of this application provides an ultra-high temperature resistant cementing system with excellent pumpability performance. The system consists of a solid component and a liquid component, with a weight ratio of 1:0.25 between the solid component and the liquid component.

The solid component is composed of 31.25% class G oil well cement, with the main mineral components including 46% C₃S, 28% C₂S, 19.7% C₄AF, and 6.4% gypsum. It also includes 6.25% silica sand (D90=163 μm), and 56.25% S95 slag powder (D90=29.863 μm), containing 29.438% SiO₂ and 14.125% Al₂O₃. Additionally, it contains 6.25% fly ash (D90=10.51 μm), containing 47.057% SiO₂ and 39.465% Al₂O₃.

The liquid component is composed of 81.56% water, 1.92% suspending agent, 5.76% dispersant, 5.76% retarder, 4.61% fluid loss reducer, and 0.39% defoaming agent.

The preparation process of the ultra-high temperature resistant cementing system with excellent pumpability performance provided by this embodiment is as follows:
Step 1: Mix cement, silica sand, and S95 slag powder in the specified proportions to obtain solid component A.
Step 2: Weigh a certain mass of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, stir the liquid components at a speed of 12000 rpm for 35 seconds. Then slowly add the solid component B obtained in step 2 to the liquid component at a low speed of 600 rpm. After the addition, stir the liquid component at a speed of 3000 rpm for 35 seconds to obtain a high-temperature resistant cementing system.

### SIXTH EMBODIMENT

The cementing system in this embodiment provides excellent pumpability performance and ultra-high temperature resistance. It consists of a solid component and a liquid component, with a weight ratio of 1:0.4.

The solid component is composed of 32.25% class G oil well cement (including 46% C₃S, 28% C₂S, 19.7% C₄AF, and 6.4% gypsum), 6.45% silica sand (D90=163 μm), 6.45% S95 slag powder (D90=29.863 μm, containing 29.438% SiO₂ and 14.125% Al₂O₃), and 54.85% fly ash (D90=10.51 μm, containing 47.057% SiO₂ and 39.465% Al₂O₃).

The liquid component is composed of 78.57% water, 2.23% suspending agent, 6.69% dispersant, 6.69% retarder, 5.36% fluid loss reducer, and 0.46% defoaming agent.

The preparation process of the ultra-high temperature resistant cementing system with excellent pumpability performance, as provided by this embodiment, is as follows:
Step 1: Mix cement, silica sand, and S95 slag powder according to the specified proportion to obtain solid component A.
Step 2: Weigh a certain amount of fly ash to obtain solid component B.
Step 3: Mix water and additives according to the specified proportion to obtain liquid component C.
Step 4: Add the solid component A obtained in Step 1 into the liquid component C, while stirring at a speed of 4000 rpm. After adding, continue stirring the liquid components at a speed of 12000 rpm for 35 seconds. Then, slowly add the solid component B obtained from Step 2 to the liquid component at a low speed of 600 rpm. After the addition, stir the liquid component at a speed of 3000 rpm for 35 seconds to obtain a high-temperature resistant cementing system.

### SEVENTH EMBODIMENT

The seventh embodiment of the present application provides an ultra-high temperature resistant cementing system with excellent pumpability performance, which consists of a solid component and a liquid component. The weight ratio between the solid component and the liquid component is 1:0.75.

The solid component is composed of 15.64% of class G oil well cement, which includes 46% C₃S, 28% C₂S, 19.7% C₄AF, and 6.4% gypsum. It also contains 28.12% of silica sand (D90=163 μm), 28.12% of S95 slag powder (D90-29.863 μm, containing 29.438% of SiO₂ and 14.125% of Al₂O₃), and 28.12% of fly ash (D90=10.51 μm, containing 47.057% of SiO₂ and 39.465% of Al₂O₃).

The liquid component is composed of 89.39% water, 1.10% suspending agent, 3.31% dispersant, 3.31% retarder, 2.65% fluid loss reducer, and 0.24% defoaming agent.

The preparation process of the ultra-high temperature resistant cementing system with excellent pumpability performance, as provided by this embodiment, is as follows:
Step 1: Mix cement, silica sand, and S95 slag powder according to the specified proportions to obtain solid component A.
Step 2: Weigh a specific amount of fly ash to obtain solid component B.
Step 3: Mix water and additives according to the specified proportions to obtain liquid component C.
Step 4: At a stirring speed of 4000 rpm, add the solid component A obtained in step 1 to the liquid component C. After adding, stir the liquid components at a speed of 12000 rpm for 35 seconds. Then, gradually add the solid component B obtained from step 2 to the liquid component at a low speed of 600 rpm. After the addition, stir the liquid component at a speed of 3000 rpm for 35 seconds to obtain an ultra-high temperature resistant cementing system.

### EIGHTH EMBODIMENT

The present embodiment provides an ultra-high temperature resistant cementing system with excellent pumpability performance, which comprises a solid component and a liquid component. The weight ratio of the solid component to the liquid component is 1:0.44.

The solid component is composed of 62.41% class G oil well cement, with main mineral components including 46% C₃S, 28% C₂S, 19.7% C₄AF, and 6.4% gypsum. Additionally, it contains 12.53% silica sand (D90=163 μm), 12.53% S95 slag powder (D90=29.863 μm, containing 29.438% SiO₂ and 14.125% Al₂O₃), and 12.53% fly ash (D90=10.51 μm, containing 47.057% SiO₂ and 39.465% Al₂O₃).

The liquid component is composed of 65.57% water, 3.58% suspending agent, 10.76% dispersant, 10.76% retarder, 8.61% fluid loss reducer, and 0.72% defoaming agent.

The preparation process of the ultra-high temperature resistant cementing system with excellent pumpability performance provided by the present embodiment is as follows:
Step 1: Mix cement, silica sand, and S95 slag powder in the specified proportions to obtain solid component A.
Step 2: Weigh a specific amount of fly ash to obtain solid component B.
Step 3: Mix water and additives in the specified proportions to obtain liquid component C.
Step 4: At a stirring speed of 4000 rpm, add the solid component A obtained in step 1 to the liquid component C. After adding, continue stirring the liquid components at a speed of 12000 rpm for 35 seconds. Then, slowly add the solid component B obtained from step 2 to the liquid component at a low speed of 600 rpm. After the addition, stir the liquid component at a speed of 3000 rpm for 35 seconds to obtain a high-temperature resistant cementing system.

### COMPARATIVE EXAMPLE 1

The preparation process follows the method described in the first embodiment, except for the different composition of the solid components. The solid component contains no slag powder and consists of 51.59% cement, 17.46% silica sand (D90=163 μm), and 30.95% fly ash (D90=10.51 μm). The fly ash contains 47.057% SiO₂ and 39.465% Al₂O₃. The liquid component consists of 75.48% water, 3.23% suspending agent, 7.09% dispersant, 5.81% retarder, 7.74% fluid loss reducer, and 0.65% defoaming agent.

### COMPARATIVE EXAMPLE 2

The preparation process follows the method described in the first embodiment, but with a different composition of solid components. The solid component contains no fly ash and consists of 40% cement, 28% silica sand (D90=163 μm), and 32% S95 slag powder (D90=29.86 μm). The slag powder contains 29.438% SiO₂ and 14.125% Al₂O₃. The liquid component consists of 76.61% water, 2.44% suspending agent, 7.31% dispersant, 7.31% retarder, 5.85% fluid loss reducer, and 0.48% defoaming agent.

Table 1 presents the comparison results of embodiments 1 to 8 and the comparative examples.

TABLE 1
Comparison Results of Embodiment and Comparative Examples

| | compressive | | Water | | Thickening property | |
|---|---|---|---|---|---|---|
| | strength/MPa | | permeability/mD | | Thickening | Initial |
| Number | 2D | 90D | 2D | 90D | time/h | consistency/Bc |
| First embodiment | 30.31 | 35.39 | 0.001 | 0.001 | 6.8 | 23.8 |
| Second embodiment | 30.35 | 46.52 | 0.0006 | 0.0005 | 6.0 | 32.9 |
| Third embodiment | 29.98 | 38.89 | 0.0008 | 0.0002 | 6.9 | 25.6 |
| Fourth embodiment | 32.66 | 37.48 | 0.0003 | 0.0002 | 6.3 | 30.5 |
| Fifth embodiment | 28.67 | 41.36 | 0.0001 | 0.0009 | 6.7 | 33.6 |
| Sixth embodiment | 29.45 | 45.77 | 0.002 | 0.0008 | 6.5 | 31.6 |
| Seventh embodiment | 25.83 | 40.39 | 0.0004 | 0.0002 | 6.2 | 29.8 |
| Eighth embodiment | 29.45 | 48.90 | 0.0002 | 0.0006 | 5.9 | 27.4 |
| Comparative example 1 | 26.86 | 53.97 | 0.003 | 0.001 | 4.5 | 56.5 |
| Comparative example 2 | 31.96 | 19.64 | 0.001 | 0.008 | 4.25 | 14.5 |

Table 1 shows that the compressive strength and water permeability of Comparative Example 1 (fly ash-silica-cement system) remain stable cured from 2 d to 90 d, but its thickening performance was very poor; the initial consistency is 56.5 Bc, and the thickening time is only 4.5 hours, unfavourable for use on site. The initial consistency of Comparative Example 2 (slag-silica-cement system) is only 14.5 Bc, however, after 90 days of curing, this system experienced severe strength retrogression (reduced from 31.96 MPa to 19.64 MPa), accompanied by the water permeability increasing from 0.001 mD to 0.008 mD. In comparison, the strength and water permeability of Embodiments 1-8 (fly ash-slag-silica-cement systems) remain stable cured from 2 d to 90 d; the initial slurry consistency ranges from 23.8 Bc to 33.6 Bc and the thickening time is in excess of 6 hours, providing good thickening time performance, advantageous for cementing in field applications. These results demonstrate that the cementing system of the present application possesses both outstanding long-term high temperature resistance and excellent slurry thickening time performance, thereby supporting the field construction application of ultra-high temperature cementing while meeting the long-term sealing requirements of cementing.

The specific preparation process of the cementing system of present application is shown in FIG. 1.

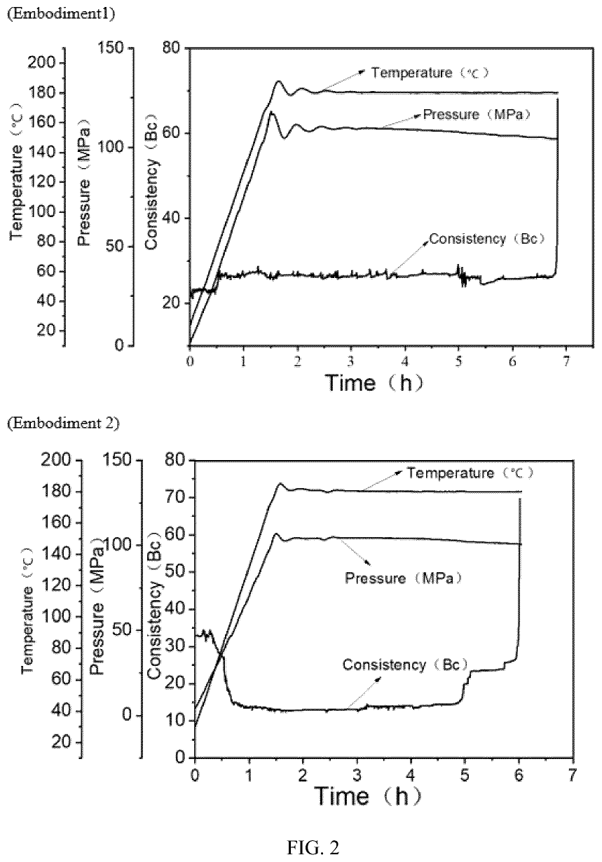

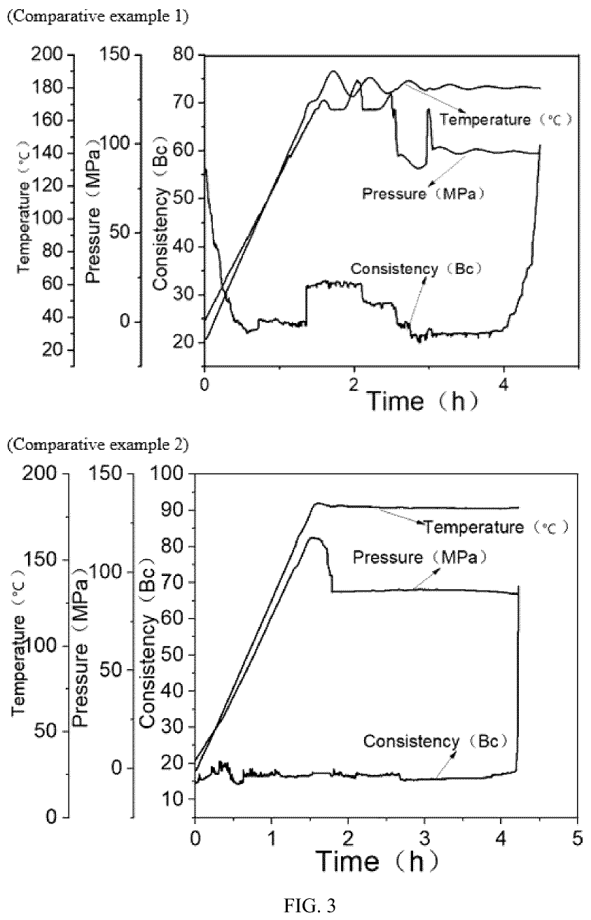

As depicted in FIG. 2 and FIG. 3, the thickening time of the embodiment under HPHT conditions typically exceeds 6 hours, with initial consistency ranging from 23.8 Bc to 33.6 Bc. The heating time to 200° C. is approximately 1.5 hours, indicating that the slurry remains in a fluid state before reaching the target temperature and pressure, thus meeting the requirements for high temperature and high pressure setting. Both Comparative Example 1 and Comparative Example 2 have thickening times exceeding 4 hours. However, the Comparative Example 1 has a relatively high initial viscosity of 56.5 Bc, making it challenging to pump. On the other hand, the Comparative Example 2 has a small initial consistency of 14.5 Bc, making it prone to bleeding problems.

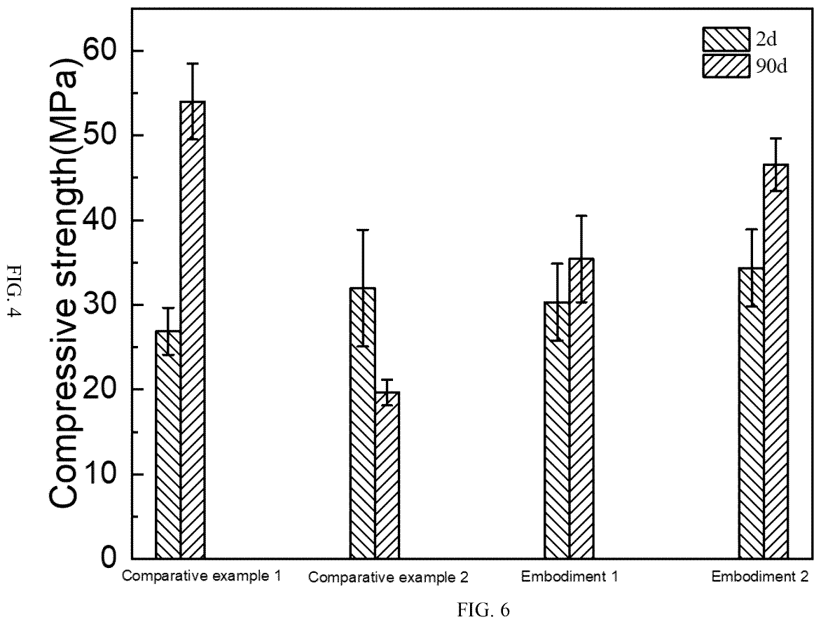

As depicted in FIG. 4, the compressive strength of slag-silica-cement system cured 90 days is significantly lower compared to the that of sample cured for 2 days. However, the compressive strength of fly ash-silica-cement system does not exhibit a noticeable decline, indicating good strength stability. Moreover, the compressive strength of fly ash-slag-silica-cement system remains relatively stable, highlighting its strength stability.

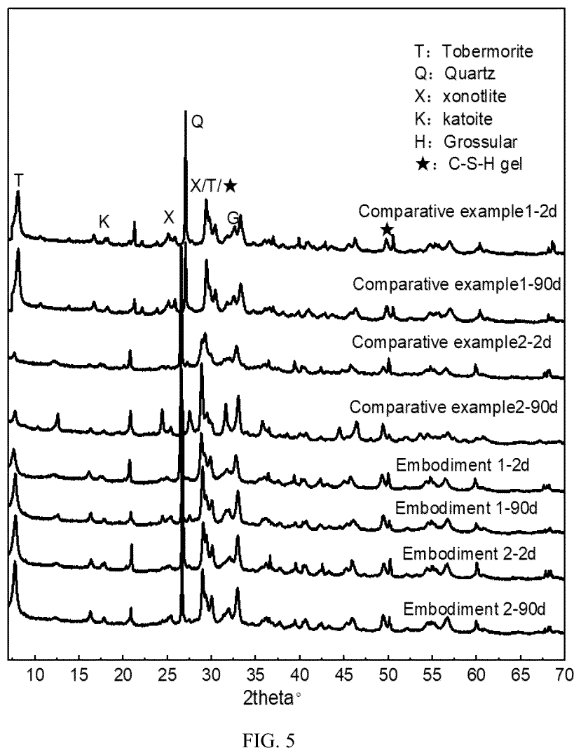

FIG. 5 illustrates the XRD patterns which show the presence of aluminium-containing mineral components such as katoite in all samples. In Comparative Example 1 and in both the first and second embodiments, these all exhibit semi-crystalline peaks in the range of 31° to 34° and remain stable as the curing time increases. In Comparative Example 2, the semi-crystalline peak sharpens significantly after 90 days, which may explain the difference in strength stability between the sample of Comparative Example 2 and the other samples.

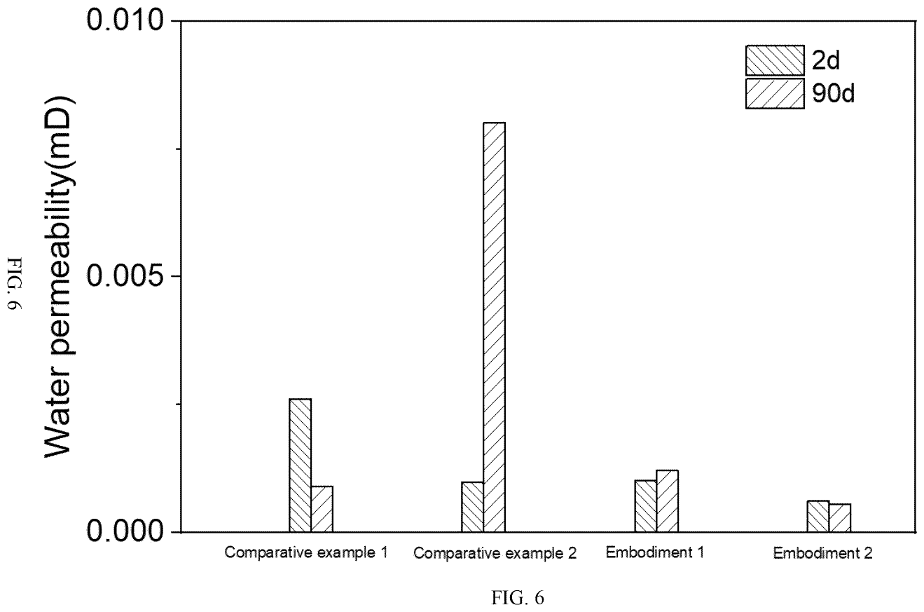

FIG. 6 shows the comparison of water permeability between the 2-day sample and the 90-day sample. When fly ash, slag powder and silica sand are added simultaneously, the water permeability of set cement remains stable from 2 d to 90 d.

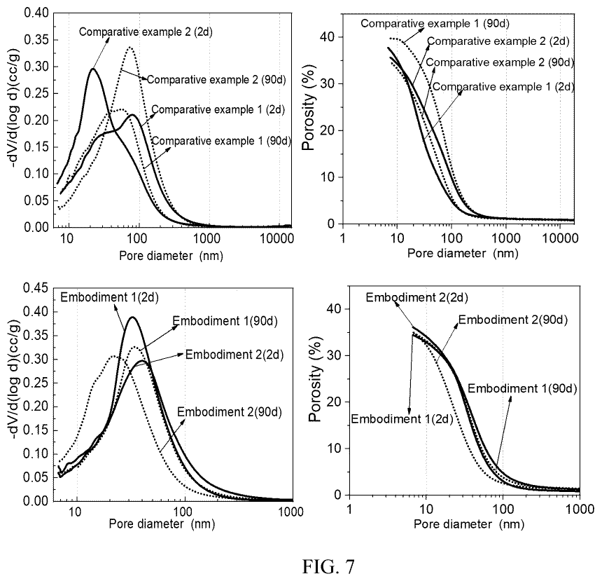

From FIG. 7 it can be seen that the addition of silica sand, fly ash and slag powder brings stability to the internal pore throat diameter of set cement after 90 d curing period compared to that of the set cement after 2 d curing period. The pore throat diameter of the second embodiment after 2 d curing period is significantly smaller than that after 90 d curing period. On the other hand, the pore throat diameter of Comparative Example 2 increases with time. The composite system of fly ash, slag powder and silica sand, as well as the composite system of fly ash and silica sand, can effectively improve the internal pore structure of set cement and contribute to the stability of the system.

The aforementioned description provides only a specific embodiment of the present application, while the scope of protection is not limited thereto. Any modifications, equivalent substitutions, or improvements made by one skilled in the art within the disclosed technical scope of the present application and following the spirit and principles thereof should be considered as falling within the scope of protection of the present application.

What is claimed is:

1. An ultra-high temperature resistant cementing system with excellent pumpability performance, which is composed of a solid component and a liquid component;
wherein a weight ratio of the solid component to the liquid component is 1: (0.23-0.83); wherein the solid component consists of cement, silica sand, fly ash and slag powder; wherein the liquid component is composed of water and additives;
wherein the solid component consists of 14-70% cement, 3-80% silica sand, 3-80% fly ash and 3-80% slag powder by weight percentage, and a weight ratio of silica sand to fly ash, or silica sand to slag powder, or fly ash to slag powder is (0.05-24): 1;
wherein the liquid component consists of 70-90% water and 10-30% additive by weight percentage.

2. The ultra-high temperature resistant cementing system with excellent pumpability performance according to claim 1, wherein the cement isclass G oil well cement.

3. The ultra-high temperature resistant cementing system with excellent pumpability performance according to claim 1, wherein a content of SiO₂ in the silica sand is more than 95%.

4. The ultra-high temperature resistant cementing system with excellent pumpability performance according to claim 1, wherein a particle size D90 of the silica sand ranges from 38.6 to 206 μm.

5. The ultra-high temperature resistant cementing system with excellent pumpability performance according to claim 1, wherein the fly ash is fly ash of coal-fired power plants.

6. The ultra-high temperature resistant cementing system with excellent pumpability performance according to claim 1, wherein the slag powder is S75 grade, S95 grade, or S105 grade slag powder.

7. The ultra-high temperature resistant cementing system with excellent pumpability performance according to claim 1, wherein the additive contains a retarder;
wherein the additive further contains at least one of a suspending agent, a dispersing agent, a fluid loss reducer and a defoaming agent.

8. A preparation method for preparing the ultra-high temperature resistant cementing system with excellent pumpability performance according to claim 1, comprising the following steps:
step 1, mix cement, silica sand and slag powder according to a proportion to obtain a solid component A;
step 2, weigh the fly ash to obtain a solid component B;
step 3, mix water and additives according to a proportion to obtain a liquid component C;
step 4, mix the solid component obtained in step 1 and the liquid component obtained in step 3 at low speed according to the proportion, and slowly adding the solid component B obtained in step 2 into it, and then stirring at the speed of 3000 rpm for 35 seconds after the addition, and obtaining a high-temperature resistant cementing system.

9. The preparation method for the ultra-high temperature resistant cementing system with excellent pumpability performance according to claim 8, wherein from step 1 to step 4, fly ash is slowly added at a low speed under the condition that other solid and liquid components are fully mixed at a high speed.
